(19) United States
(12) Patent Application Publication
(10) Pub. No.: US 2006/0090577 A1
(43) Pub. Date: May 4, 2006

(54) Apparatus and methods for testing containers

(75) Inventors: Aaron Bates, Powder Springs, GA (US); Frank Middleton, White, GA (US)

Correspondence Address: PARKS KNOWLTON LLC, 1117 PERIMETER CENTER WEST, SUITE W307, ATLANTA, GA, 30338, US

(73) Assignee: MeadWestvaco Packaging Systems, LLC

(21) Appl. No.: 11/264,569

(22) Filed: Oct. 31, 2005

Related U.S. Application Data
(60) Provisional application No. 60/623,905, filed on Oct. 31, 2004.

(51) Int. Cl. G01M 19/00

(52) U.S. Cl. 73/865.3; 73/865.9

(57) ABSTRACT

An apparatus automatically tests the effect of pendular motion on the integrity of cartons or other containers having handles, by grasping the handles with a simulated hand connected to a simulated arm, which swings the carton along an arcuate path according to a predefined test protocol. A first test protocol simulates removal of the carton from an elevated shelf. A second test protocol simulates the oscillating motion of a human carrying a carton by its handle. A third test protocol simulates a human swinging the carton upward to an elevated shelf. The simulated hand may be connected to the simulated arm by a simulated wrist that allows articulation of the hand during the test, thereby more closely approximating handling of the carton by a human user. The simulated arm may be caused to pivot or oscillated by the force of gravity and alternatively, by a mechanical or electromechanical drive system.

### RELATED APPLICATION

This invention claims the benefit of the filing date of and incorporates by reference U.S. Provisional Application Ser. No. 60/623,905 entitled “Apparatus and Methods for Testing Containers,” filed on Oct. 31, 2004.

### TECHNICAL FIELD

This invention relates generally to testing cartons or other containers, and more particularly, to systems and methods for testing a container using periodic or non-linear motion.

### BACKGROUND OF THE INVENTION

Containers, such as cartons for encasing and dispensing articles, are useful for enabling a user to consolidate, transport, store, and access multiple articles. To facilitate ease of use, a typical container includes a handle or other attached or integral component that enables the articles within to be carried by a user as an article group. Clearly, the carton and the handle must be sufficiently strong to enclose and support the suspended weight of the articles when the container is being moved or carried. Therefore, it is advisable to test new container designs prior to placing the containers in commerce.

Prior art approaches to container testing have focused on the ability of the container to withstand linear forces by simulating a relatively sudden “dead lift” from a resting state or a drop from a certain height, where the dead lift or drop is performed by a machine. However, such tests fail to assess the ability of a container to withstand the more realistic forces imposed by a human user, including removal of a loaded container from a shelf, carriage of the container while the user walks, and placement of the loaded container on a shelf.

There is a need, therefore, for systems and methods for testing the integrity of a container and its handle that simulate more realistic non-linear forces that occur in the course of handling the container by a human user.

### SUMMARY OF THE INVENTION

The various embodiments of the present invention overcome the shortcomings of the prior art by providing systems and methods for structural integrity testing by exposing a container and means for carrying a container to non-linear forces, which simulate or approximate use by human user.

Generally, each of the various embodiments of the novel container testing apparatus performs one or more novel methods for testing the performance of a container. The apparatus and methods of the invention generate and apply forces to the container to simulate the container being used by a human user, in particular, by simulating the container being raised, lowered, carried, and/or swung by the user. The apparatus is useful for testing various types of containers that are designed to be carried by one or more human hands, including cartons, cases, bags, purses, sacks, suitcases, packages, and the like. For the purposes of illustration and not of limitation, a container will be described herein as a carton for enclosing and carrying multiply-packaged products such as cans, bottles, or singly-packaged and protectively-covered goods.

More specifically, the apparatus for testing the integrity of a carton includes an approximation of a human arm for lifting, supporting and carrying the carton, and the arm includes an approximation of a human hand for grasping the carton. The apparatus generates forces by causing the carton to follow a range of motion that at least approximates an arcuate or at least partially circular path as defined by the pendulum-like swing of the arm. In certain embodiments of the invention, the container testing apparatus includes a frame comprising a rectangular periphery having four sides and a base. The vertical edges of the four sides are preferably connected one to the next at perpendicular corners. Each of the sides is preferably framed, and the area within the outline created by the frame may be at least partially open.

According to one aspect of the invention, the arm is connected in the manner of a pendulum such that it is pivotably connected at one end to an upright support or other suitable support means, such as a panel, crossbeam, or post that is preferably connected or integral to the frame. The pivotable connection comprises a pivot point about which the arm swings. In certain embodiments, the arm swings along a two-dimensional longitudinally oriented plane having a horizontal axis that is substantially parallel to the base, as well as a vertical axis that is perpendicular to the base. At the distal end of the arm, the simulated hand or other grasping means is connected for engaging or otherwise detachably connecting the arm with the carton, preferably by grasping a handle or other carrying means attached or integral to the carton. Once a carton is engaged by the hand, the apparatus serves as a means for testing the integrity of the carton or the carton handle by causing or allowing the carton to move along an arcuate or at least partially circular path along the two dimensional plane. The apparatus can cause the carton to move by applying force via a mechanical or electromechanical drive means for causing movement of the arm about the pivot point, such as servo motor, crank, or a weight or spring driven escapement. The apparatus can also allow the carton to move by force of gravity and kinetic energy associated with the mass of a carton having been displaced from a position of equilibrium.

According to one aspect of the invention, the apparatus includes an arm that is pivotally attached to and supported by the frame.

According to another aspect of the invention, the arm includes a means for grasping a handle or other carrying means that is integral to or attached to the carton.

According to another aspect of the invention, the grasping means functions as a simulated hand that is connected to the arm by a means for articulation that simulates the action of a human wrist by allowing the grasping means to articulate, or move with respect to the arm about a movable connection with the arm. The articulation means includes or is associated with a pivot point, a means for self-centering or rectifying the position of the grasping means, and a means for dampening the articulation.

The apparatus of the invention preferably tests carton integrity by performing automated and preferably programmable test protocols that include the various methods of the present invention. According to one aspect of the various methods of the invention, a carton at rest is engaged by the arm, which swings the carton along a two dimensional plane until the carton fails the integrity test, or until swinging ceases by operation of gravity or by assertion of a contravening force. The carton moves or is moved from a resting state at one point on the two dimensional plane to at least one transition point on the two dimensional plane. At each transition point, the carton either fails the integrity test or completely decelerates or otherwise reaches a velocity of zero. In other words, the carton is swung from a resting state at one point to a failure point at which the carton fails the integrity test, or to a transition point at which gravity or a braking force applied by the apparatus causes the carton to completely decelerate at least momentarily. The carton may continue to move to any number of transition points, with its direction preferably reversing between each transition point.

A first embodiment of a method of the invention comprises a shelf drop test, which is intended to simulate removal by a human of a carton from a raised platform such as a shelf, and the ensuing arcuate path along which the carton would travel from the shelf to one side of the human's body. This method is performed by placing the carton on the shelf, which is mounted on an end wall of a container testing apparatus, causing the hand to grasp the carton, and then removing the support provided by the shelf such that the carton swings downward from the level of the shelf, driven by gravitational forces associated at least in part with the weight of the carton and the height of the shelf.

A second embodiment of a method for testing a carton comprises a shelf lift test, which simulates the forces caused by an upswing, such as placement by a human of the carton on a shelf. Accordingly, the carton is engaged by the arm, which is preferably at equilibrium at a first point wherein a hypothetical line connecting the first point to the pivot point is parallel to the vertical axis of the two dimensional plane. A drive system is engaged to cause the arm to rotate to a second point at the height of a hypothetical shelf by causing the arm to pivot from the equilibrium point to the shelf height point.

A third embodiment of a method for testing a carton comprises a swing arm test, which simulates the forces caused by oscillation of the carton, such as when a human user carries a carton with one hand while the user walks and swings the carton back and forth, the carton oscillating about the user's shoulder.

As another aspect of the invention, a human-machine interface permits an operator to specify test parameters such as velocity, acceleration, deceleration, position, number of cycles to be performed, container mass, force, and duration.

The foregoing has broadly outlined some of the aspects and features of the present invention, which should be construed to be merely illustrative of various potential applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

### BRIEF DESCRIPTION OF THE DRAWINGS

FIG. 1 is a perspective view of an exemplary carton testing apparatus, according to certain embodiments of the present invention.

FIG. 2 is an elevation of an arm of an exemplary carton testing apparatus.

FIG. 3 is an enlarged view of a self-centering means according to certain embodiments of the present invention.

FIG. 4 is a cross-sectional view of a portion of the arm of FIG. 2.

FIG. 5 is a cross-sectional view of an exemplary means for controlling an exemplary arm.

FIG. 6 shows the relative positions of a carton and the components of the carton testing apparatus during performance of an exemplary method for testing the container.

FIG. 7 shows the relative positions of a carton and the components of the carton testing apparatus during performance of another exemplary method for testing the container.

FIG. 8 shows the relative positions of a carton and the components of the carton testing apparatus during performance of yet another exemplary method for testing the container.

FIG. 9 is a block diagram showing certain elements of an exemplary human-machine interface according to the present invention.

### DETAILED DESCRIPTION

As required, detailed embodiments of the present invention are disclosed herein. It will be understood that the disclosed embodiments are merely examples to illustrate aspects of the invention that may be embodied in various and alternative forms. The figures are not necessarily to scale, and some features may be exaggerated or minimized to show details of particular components. In other instances, well-known materials or methods have not been described in detail to avoid obscuring the present invention. Therefore, specific structural and functional details disclosed herein are not to be interpreted as limiting, but as a basis for the claims and for teaching one skilled in the art to variously employ the present invention.

Referring now to the drawings in which like numerals indicate like elements throughout the several views, the drawings illustrate certain of the various aspects of an exemplary embodiment of a container testing apparatus according to the teachings of the present invention. In the embodiments described herein, the container of the present invention is a carton for enclosing, carrying, and dispensing articles such as beverage cans or bottles. Generally described, the carton is formed from a foldable sheet material such as paperboard, corrugated board, plastic, laminates, any combination thereof, or the like.

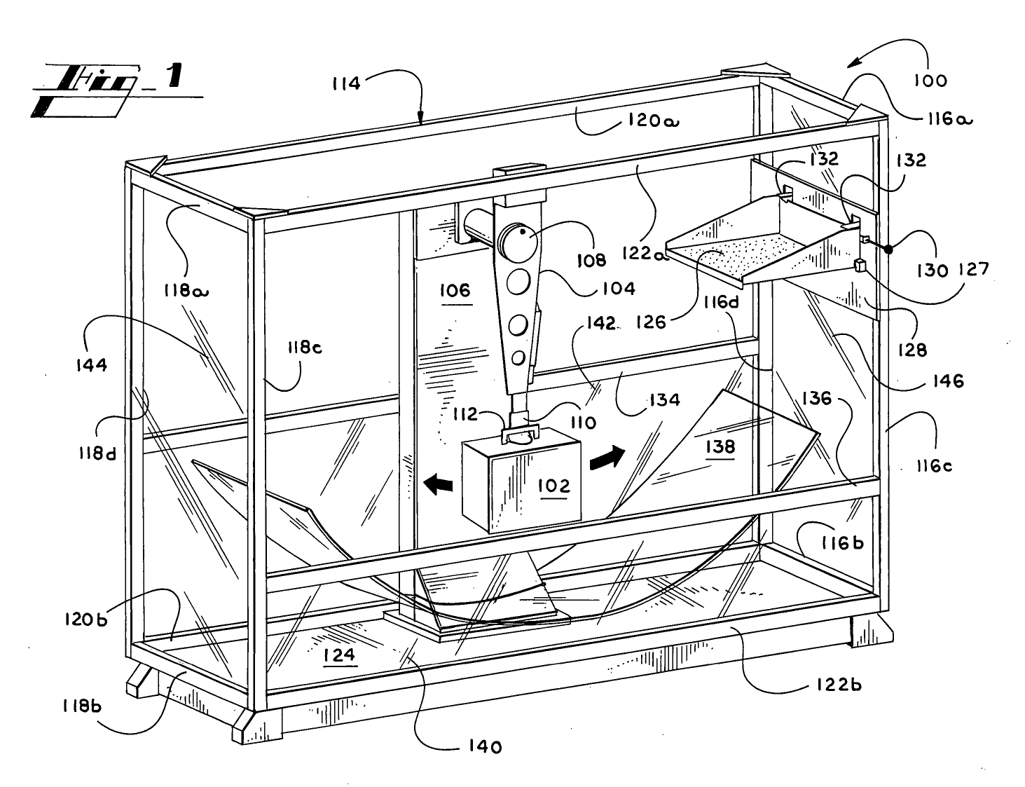

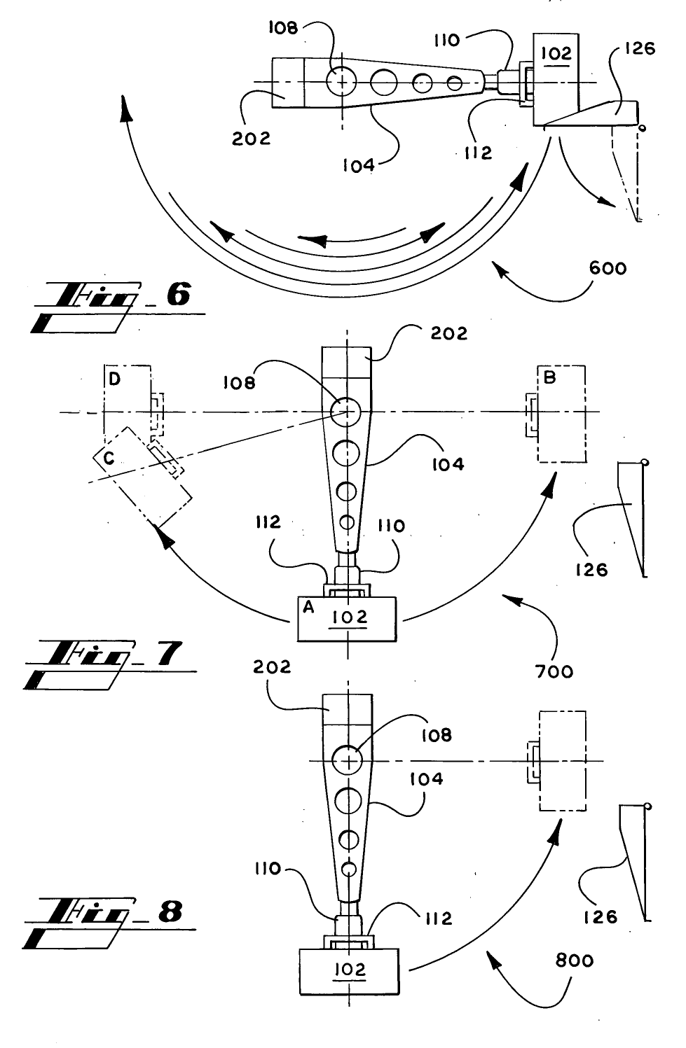

FIG. 1 is a perspective view of an exemplary carton testing apparatus 100 that is illustrative of certain of the various aspects of the present invention. The carton testing apparatus 100 is preferably constructed to safely and effectively test a container such as beverage carton 102 in a test environment that is easily monitored either visually or electronically by one or more operators or monitoring devices. According to the testing methods described in more detail below with respect to FIGS. 6 through 8, the carton 102 is detachably connected to a pendulum arm 104 that is pivotably connected to a support means such as post 106 such that the pendulum arm 104 can pivot about a pivot point, which is shown as turntable 108. The carton testing apparatus 100 applies forces to the carton 102 by causing the carton 102 to swing from pendulum arm 104 according to a predefined test protocol that prescribes the initial position of rotation of the pendulum arm 104, the angle of throw or amplitude of the swing, the acceleration, deceleration, and velocity of the swing, and the extent of arm rotation, among other potential parameters.

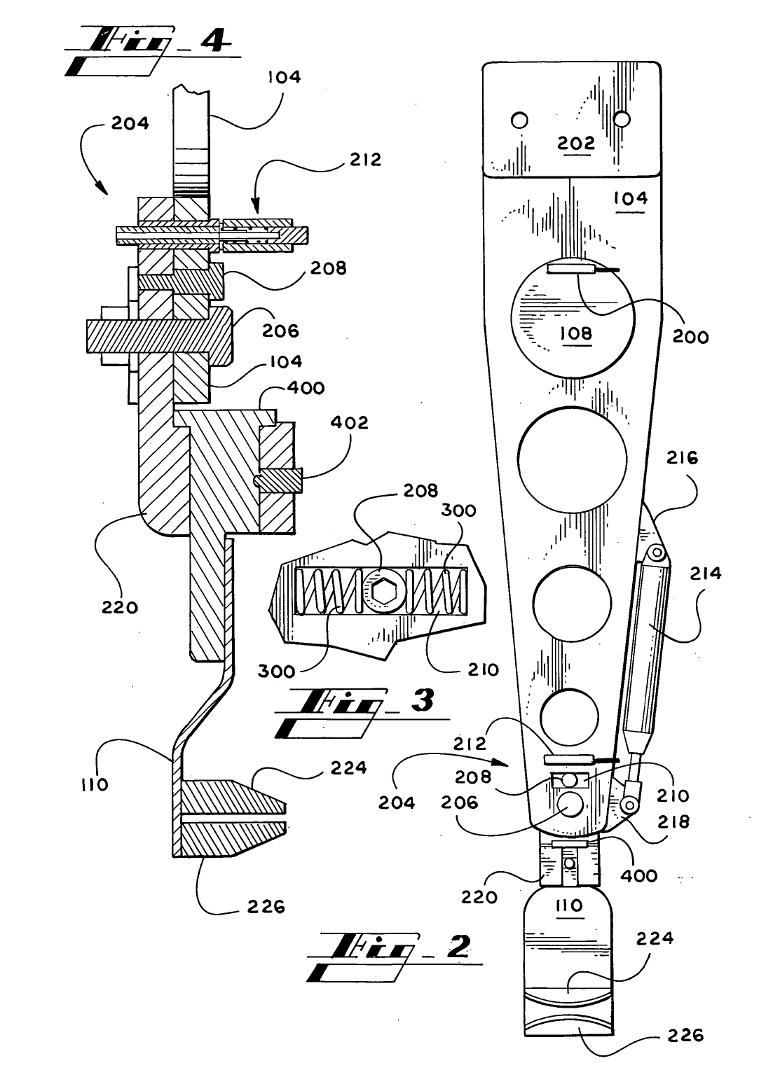

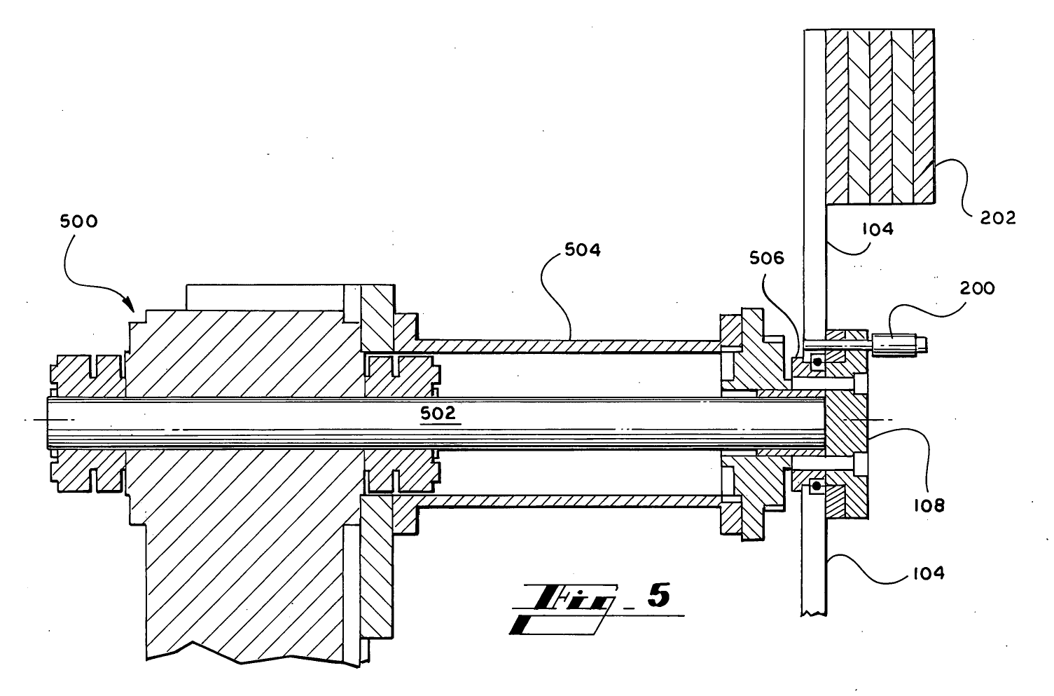

The pendulum arm 104 includes a grasping means 110 for grasping the carton 102, which in certain embodiments, is a simulation of a human hand (as best shown in FIGS. 2 and 4). The grasping means 110 includes upper digit 224 and lower digit 226 which enable the grasping means 110 to interface with a handle 112 or any other typical carrying means, such as a strap or a hand aperture. The dimensions and materials that define the grasping means 110 are preferably selected to enable the grasping means 110 to engage the carton 102 by taking hold of the carton 102 in approximately the same manner as would a human, such as by grasping the carton 102 by the handle 112 or other carrying means.

To provide additional stability and to safely establish the boundaries of the carton testing environment, certain embodiments of the carton testing apparatus 100 are enclosed within the perimeters of a frame 114. The frame 114 can include various load bearing, non-load bearing, reinforcing, and non-reinforcing members, which may be arranged in any suitable fashion so as to construct the carton testing apparatus 100 in any suitable configuration, size, or shape. In FIG. 1, the carton testing apparatus 100 is rectangular in configuration, having a first end, a second end, a rear side, a front side, and a base. The first end is defined by a horizontal upper beam 116a, a horizontal lower beam 116b, a vertical front beam 116c, and a vertical rear beam 116d, which are all connected end to end to form a rectangle. The second end of the carton testing apparatus 100 is defined by a horizontal upper beam 118a, a horizontal lower beam 118b, a vertical front beam 118c, and a vertical rear beam 118d, which are also connected end to end. The rear side of the carton testing apparatus 100 is defined by horizontal upper beam 120aand horizontal lower beam 120b. The front side of the carton testing apparatus 100 is defined by horizontal upper beam 122a and horizontal lower beam 122b. The horizontal lower beams 116b, 118b are connected end to end with horizontal lower beams 120b, 122b, thereby defining the bounds of base 124, which is constructed of a rigid material such as steel. Base 124 preferably includes a welded steel frame with mounting feet and a steel support panel mounted on the welded frame. Base 124 may be bolted or otherwise anchored to the floor of the test area or adjustably mounted, for instance, on offset bolts, so that carton testing apparatus 100 can be kept level.

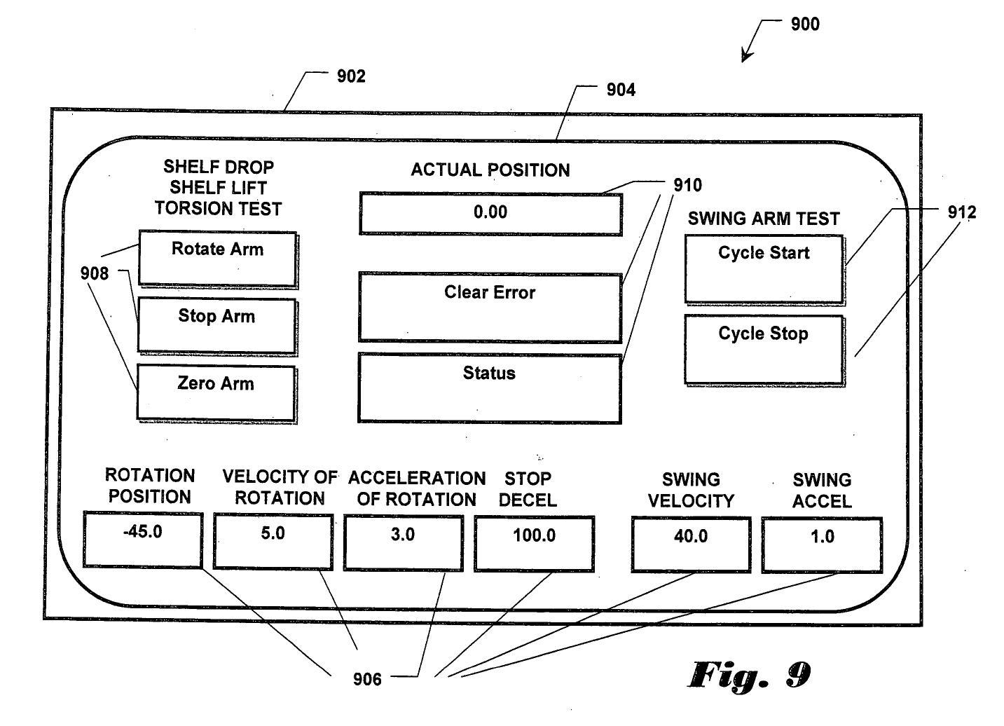

The carton testing apparatus 100 also includes a platform 126 that is mounted on a panel 128 that spans the distance between and is connected to vertical front beam 116c and vertical rear beam 116d. The platform 126 is pivotally connected to panel 128 by one or more pins 127 for swivel movement between raised and lowered positions. The platform 126 can be locked in the raised position (shown in FIGS. 1 and 6) wherein it projects inwardly and generally horizontally from the first end of the carton testing apparatus 100 and is substantially parallel to base 124. The platform 126 can be lowered or downwardly rotated to the lowered position (shown in FIGS. 7 and 8) by deactivating a support mechanism such as by removing or a pin or shifting a lever 130. Lever 130 controls the position of one or more catches 132 that function either to brace the platform 126 in the raised position or to release platform 126 such that platform 126 assumes the lowered position where platform 126 is disposed substantially perpendicular to base 124.

The frame 114 may also include additional structural members, including beams 134 and 136, which serve at least in part to fortify the frame 114 and to further define the test environment, as well as shield 138, which serves at least in part to catch carton 102 or its contents if the carton is dropped or loses structural integrity during a testing protocol. Shield 138 is preferably constructed of a strong, clear material such as LEXAN or PLEXIGLAS so as to reduce obstructions to operators and monitoring equipment. Additional shields formed of similar materials may further define and ensure safety of the test environment, including but not limited to, front and rear shields 140 and 142 which enclose the areas below beams 136 and 134, respectively, as well as end shields 144 and 146 which enclose the entire respective ends of the frame 114.

FIG. 2 is a plan view of the pendulum arm 104 as viewed from the front side of the exemplary carton testing apparatus 100. The pendulum arm 104 may be constructed of aluminum, steel, or any material that has sufficient strength and rigidity to transfer and withstand the forces generated by swinging containers of various sizes, shapes, and weights around a pivot point, which is approximated by turntable 108.

To position the pendulum arm 104 manually rather than by means of a drive system (described in detail below), a removable drive pin 200 (best shown in FIG. 5) inserted through both the turntable 108 and the pendulum arm 104 can be removed. To reduce or eliminate the influence of the weight of the arm itself on the test results, or to counterbalance the weight of the loaded carton 102, an adjustable counterweight 202 is fixed at an end of the pendulum arm 104 opposite the end to which the grasping means 110 is attached. The adjustable counterweight 202 shown comprises a series of plates that are bolted onto the pendulum arm 104, one or more of which can be removed to yield the necessary weight for counterbalancing.

Certain embodiments of the present invention provide articulation of the connection between the pendulum arm 104 and the grasping means 110. To that end, the embodiment shown includes articulation means 204 for simulating the flexibility of the human wrist by functioning as an interface between the pendulum arm 104 and the grasping means 110 that allows the grasping means 110 to pivot and flex with respect to the pendulum arm 104. Preferably, the grasping means 110 moves in a controlled manner as if it were a human hand, the motion of which is limited at least in part by tendons and bones. Thus, the articulation means 204 functions as an approximation of a human wrist, flexibly connecting pendulum arm 104 to grasping means 110, which is the approximation of a human hand.

In the embodiment shown, the articulation means 204 pivots about a pivot point such as shoulder screw 206, or any other fastener that has a shank that can be used to connect and to function as a bearing or pivot surface between pendulum arm 104 and articulation means 204. The articulation means 204 can be adapted to include a self-centering or rectifying means for automatically centering the grasping means 110, i.e., to resist and at least partially counteract forces encouraging the grasping means 110 to pivot.

FIG. 3 is an enlarged view of an example of a self-centering means comprising at least the combination of dowel 208, aperture 210, and springs 300. Dowel 208 is connected or integral to articulation means 204 and protrudes at least partially into a depression, groove, or aperture 210, which is formed in pendulum arm 104. As grasping means 110 pivots in one direction, dowel 208 moves with respect to aperture 210 in the direction opposite the pivoting of the grasping means 110. The range of motion of dowel 208 is ultimately limited by the width of aperture 210 and the force required to shift dowel 208 is proportional to the spring constant or the sum of the spring constants of one or more elastic bodies, such as springs 300 or elastomeric rings, which are preferably inserted in aperture 210 and on either side of dowel 208. Each spring may be connected to dowel 208 and/or to at least one surface of aperture 210. In certain embodiments, a preload screw is added to control the level of resistance provided by the self-centering means by compressing or decompressing the springs 300 prior to initiation of a test cycle. Alternatively, when pivoting of the grasping means 110 is not desirable at all, a locking pin 212 can be inserted to lock the action of the articulation means 204.

The rate of motion of the grasping means 110 with respect to the pendulum arm 104 is preferably controlled by a dampening means 214, which discourages rapid or extreme pivoting of the grasping means 110. As a non-limiting example, the dampening means 214 shown in FIG. 2 is a dashpot having a piston that moves within a cylinder containing oil, which is known in the art as one of various means for cushioning or damping movement of a mechanical part to avoid shock. The dampening means 214 shown is connected to pendulum arm 104 and to the articulation means 204 by brackets 216 and 218.

Articulation means 204 may include an integral or interconnected portion that functions as a rotator cuff 220. In certain embodiments, the rotator cuff 220 is rotatably associated with a rotator pin 400 to which the grasping means 110 is directly connected. The rotator pin 400 permits the grasping means 110 to swivel around the longitudinal axis of the pendulum arm 104. To at least temporarily fix the grasping means 110 at a predetermined angle of rotation, a spring plunger 402 (best shown in FIG. 4) is inserted through the rotator cuff 220 to engage one or more predrilled and prealigned detent marks on the rotator pin 400 as the grasping means 110 is swiveled along with the rotator pin 400. For example, detent marks disposed at 45 degree intervals around the rotator pin 400 would enable an operator to easily swivel the grasping means 110 either clockwise or counterclockwise from the position shown in FIG. 2 to relative positions at 45, 90, 135, 180, 225, 270, and 315 degrees. Those skilled in the art will readily recognize controlled rotation of the grasping means 110 can be achieved electromechanically, e.g., via a servo motor.

The total range of pivoting motion of the grasping means 110 is restricted, in certain exemplary embodiments to approximately 30 degrees, at least in part by mechanical interaction between cuff 220 and the distal end of pendulum arm 104, the width of aperture 210, and the constraints of dampening means 214.

FIG. 5 is a cross-sectional view of an exemplary system 500 for driving the motion of an exemplary pendulum arm 104. The drive system 500 is preferably any suitable manual or automatic means for generating oscillating motion of the pendulum arm 104, preferably by converting rotary motion of a shaft 502 to oscillation. Examples of suitable drive systems include, but are not limited to, a servo motor and drive, an electric or pneumatic rotary actuator, or a manual crank. The shaft 502 is enclosed and sealed within a housing 504 to prevent the entrance of foreign material. Shaft 502 is associated with turntable 108 via arm hub 506 such that rotation of shaft 502 translates into rotation of turntable 108. It should be noted that other embodiments of the invention may additionally or alternatively provide reciprocal motion or circular motion of the pendulum arm 104.

The drive system 500 is preferably controlled by a controller (not shown) that enables an operator to specify test parameters via a human-machine interface (HMI), which is described in more detail below with reference to FIG. 9. The controller preferably includes a processor that processes the test parameters and translates the parameters into control signals for controlling the action of the drive system 500, and a memory for storing and launching executable instructions such as computer programs. Various test parameters can be specified, including but not limited to, the angle or position of rotation of the arm at various times before or during a test protocol, the velocity at which the pendulum arm 104 is rotated, the acceleration at which pendulum arm 104 is rotated, the deceleration of pendulum arm 104 typically at the end of a test protocol, and the velocity and acceleration of each swing cycle of a cyclical test protocol.

The various embodiments of carton testing apparatus 100 described above are utilized to perform the novel carton testing protocols of the invention. Three test protocols will be described in detail below, although the carton testing apparatus 100 can be adapted to perform other testing protocols without departing from the spirit or scope of the invention.

Shelf Drop Test

FIG. 6 is a diagram showing the relative positions of a carton 102 and the components of the carton testing apparatus 100 during performance of a carton testing protocol that is hereinafter referred to as a Shelf Drop Test. The Shelf Drop Test is designed to simulate a user removing a carton 102 from a platform 126 such as a shelf, wherein the user allows the carton 102 to pivot about the user's shoulder and to swing downward along an arcuate path 600 from the level of the platform 126 to at least the lowest point along arcuate path 600, which is defined at least in part by the angular extension of the user's arm. Accordingly, the pendulum arm 104 of the carton testing apparatus 100 is an approximation of the user's arm, the grasping means 110 is an approximation of the user's hand, and turntable 108 is an approximation of the user's shoulder. As shown, the platform 126 is positioned at the height of the user's shoulder, although its height may be adjusted to simulate removal of carton 102 from shelves having any of various distances from floor level so long as the relative platform height is sufficient to require the pendulum arm 104 to pivot from its equilibrium position (hanging vertical) to engage a carton on the platform 126.

FIG. 6 illustrates the initial position of certain elements of the carton testing apparatus 100 for performance of the Shelf Drop Test. At the initiation of the shelf drop test, platform 126 is in the raised position, extending generally horizontally from a first end of the carton testing apparatus 100 such that the upper surface between the proximal and distal edges of platform 126 is not perpendicular and is preferably substantially parallel to the base 124. A carton 102 is placed on the upper surface of the platform 126, and is preferably positioned such that the carton 102 is on its side with its handle 112 extending beyond the distal edge of the platform 126. Drive pin 200 is removed to disengage drive system 500, which is preferably deenergized. The pendulum arm 104 is mechanically or otherwise repositioned to place the grasping means 104 in association with the handle 112 of the carton 102. Locking pin 212 may be removed or remain inserted for the Shelf Drop Test.

The Shelf Drop Test is initiated by deactivating the platform support mechanism by operating lever 130, which causes at least the distal edge of platform 126 to fall away thereby removing support from the carton 102. The gravitational torque associated with the weight of the carton 102 and of the pendulum arm 104, either of which may be counterbalanced at least in part by counterweight 202, causes the unsupported carton 102 to swing from pendulum arm 104 along arcuate path 600 that defines the maximum amplitude of oscillation of the pendulum arm 104. The protocol of the Shelf Drop Test may allow the carton 102 to oscillate along successively smaller segments of path 600 until the pendulum arm 104 reaches equilibrium in a vertical position. Alternatively, the operator or controller may be required to brake or limit the oscillation to a predefined number of swings. The primary goal of the test is to determine whether the carton 102 and the handle 112 can withstand the various forces generated by the initial removal of the carton 102 from the level of the platform 126.

Swing Arm Test

FIG. 7 is a diagram showing the relative positions of a carton 102 and the components of the carton testing apparatus 100 during performance of another exemplary method for testing the carton 102, which is hereinafter referred to as the Swing Arm Test. The goal of the Swing Arm Test is to test the ability of the carton 102 and handle 112 to withstand forces generated when the carton 102 is swung repeatedly back and forth, such as when a human user walks while carrying the carton 102 by its handle 112. To prepare for performing the Swing Arm Test, the carton testing apparatus 100 is adapted to more closely simulate the oscillating arm swing of a human, and may also simulate the vertical motions that accompany a typical human gait.

With reference to FIG. 7, the initial state of the carton testing apparatus 100 is as follows. At initial position A, the pendulum arm 104 is at equilibrium, hanging vertically downward such that the longitudinal axis of pendulum arm 104 is perpendicular to the base 124. Drive pin 200 is inserted to engage the drive system 500. Locking pin 212 may be removed or remain inserted for the Swing Arm Test. The removal of locking pin 212 enables articulation of articulation means 204 so as to more accurately approximate the flexibility of a human wrist. Grasping means 110 is rotated such that the length of carton 102 is aligned parallel to the plane of oscillation. Carton 102 is engaged by grasping means 110 by placing handle 112 between upper digit 224 and lower digit 226. The digits 224, 226 may be clamped down around or otherwise adjusted to fixedly engage handle 112 to prevent the carton 102 from being dropped in the absence of a failure of the carton 102 or the carton handle 112. Platform 126 is not needed in the Swing Arm Test, and thus is held in the lowered position.

The controller is programmed with the desired test protocol by inputting or uploading the appropriate control parameters via the HMI. The operator preferably launches a test cycle by pressing a CYCLE START button on the HMI or issuing a voice command. Alternatively, the test cycle begins at a predetermined time or delay interval. The drive system 500 drives the pendulum arm 104 to oscillate through multiple consecutive swing cycles, thereby causing carton 102 to traverse path 700 repeatedly. During each cycle of oscillation, the carton 102 swings between two extreme points B and D on path 700, each swing preferably having an amplitude that is substantially equal to the amplitude of each previous and each subsequent swing. It should be noted that when the Swing Arm Test is performed with locking pin 212 removed, the articulation means 104 permits the grasping means 110 to flex somewhat in opposition to the forces generated by swinging the carton 102. For example, at position C, the grasping means 110 may flex at an angle no greater than its maximum range of motion, which for the purposes of illustration and not limitation, is ±15 degrees from center.

The Swing Arm Test continues until the carton 102 or the carton handle 112 fails, for a predetermined number of swings, for a predetermined duration, or until a predetermined swing velocity has been achieved. If the integrity of the carton 102 is preserved until the Swing Arm Test ends, the carton 102 has passed. A carton also may be rated by the number of swings or velocity withstood without failure.

Shelf Lift Test

FIG. 8 illustrates the relative positions of a carton and the components of the carton testing apparatus during performance of yet another exemplary method for testing the container, which is hereinafter referred to as the Shelf Lift Test. The object of the Shelf Lift Test is to simulate functional loads experienced during lifting of the carton 102, such as when a human user lifts the carton 102 to place it on a relatively high shelf. In particular, the torsional strength of the handle 112 is tested by rotational forces that are generated by the grasping means 110 on the handle 112 as the carton 102 is moved along an arcuate path 800. In this manner, the propensity for the handle 112 to tear away from the carton 102 can be assessed.

For performance of the Shelf Lift Test, the initial state of the carton testing machine 100 is as follows. Pendulum arm 104 is at equilibrium, hanging vertically downward such that the longitudinal axis of pendulum arm 104 is perpendicular to the base 124. Drive pin 200 is inserted to engage the drive system 500. Locking pin 212 is inserted to disable articulation of articulation means 204. Carton 102 is engaged by grasping means 110, which grasps handle 112 between upper digit 224 and lower digit 226. Platform 126 is not needed in the Shelf Lift Test, and thus is held in the lowered position.

The controller is programmed with the desired test protocol by inputting the velocity at which the pendulum arm 104 will be rotated, the extent to which the pendulum arm 104 will be rotated, and the acceleration and deceleration of the rotation of the pendulum arm 104. The operator then launches the test cycle, causing the carton testing apparatus 100 to lift carton 102 a single time through path 800.

If the carton 102 or the carton handle 112 fails during the single lift performed as the Shelf Lift Test, then the carton 102 has failed. If the integrity of the carton 102 is preserved, then the carton 102 has passed.

It is contemplated that the carton testing apparatus may be adapted to perform additional test protocols, including but not limited to a Torsion test that is similar to the Shelf Lift Test, except that the grasping means 110 is caused to rotate a quarter turn, or 90 degrees, while the carton 102 is lifted.

The Human-Machine Interface

The HMI 900 is a user interface that interfaces with the controller, which controls components of the carton testing apparatus 100 according to the program instructions, and/or according to operator inputted parameters received via input/output (I/O) devices associated with the HMI 900. Suitable I/O devices include any integral or remote combination of keypad, joystick, voice recognition devices, sound generation devices, and viewable display functionality capable of relaying data to or from the controller.

The controller can include any suitable microprocessor circuit, microcontroller, or similar data processing device that executes program instructions stored in a memory, while incorporating the parameters received via the I/O devices. Examples of suitable processing devices include programmed general or special purpose mobile device microprocessor, micro-controller and peripheral integrated circuit elements, ASIC or other integrated circuit, digital signal processor, hardwired electronic or logic circuit such as a discrete element circuit, programmable logic devices such as a PLD, PLA, FPGA or PAL, and the like. In general, the controller is any device capable of implementing the functionality described herein, and may comprise any combination of hardware, firmware, and software.

The memory can be implemented using any suitable combination of readable, writable, and/or re-writable volatile (e.g., dynamic RAM or static RAM) or non-volatile (e.g., ROM, PROM, EPROM, EEPROM, optical ROM disk, or flash) memory elements. In general, the memory is any device capable of temporarily or permanently storing data.

FIG. 9 is a block diagram showing certain elements of an exemplary HMI 900. According to this embodiment, the HMI 900 comprises a monitor 902 with a touch screen 904 for displaying the components of a Graphical User Interface (GUI). The GUI includes various user interface controls, including but not limited to buttons, menus, list boxes, text windows, and dialog boxes. The controls may alternatively or exclusively receive or display data and commands. As shown, the HMI 900 controls correspond to the particular test protocol that the carton testing apparatus 100 will perform. For instance, the controls primarily related to the Shelf Drop, Shelf Lift, and Torsion Tests are grouped toward the left of the display screen 904, and controls primarily related to the Swing Arm Test are grouped toward the right of the screen 904. Common controls are grouped in the middle of the screen 904.

To input the parameters corresponding to a particular test, an operator adjusts the state of a variable control, such as text boxes 906 until the variable control indicates the desired value. The variable controls may also function to display the status of the parameters during a test cycle, for example whether the desired swing velocity has been achieved. To position the components of the carton testing apparatus 100, the operator pushes one or more single-action controls, such as buttons 908 that cause the pendulum arm 104 to reposition itself.

The HMI 900 may also include status indicators 910 that indicate the existence and state of one or more conditions, as well as start/stop controls 912 that initiate or terminate a test. The controller may receive status data from the operator, who may for example, push a button to indicate that the operator has visually detected a failure of the carton. The controller may also receive status data from any number of sensing or metering devices, such as strain gauges, tachometers, optical, auditory, or thermal sensors, motion detectors, or any other means for measuring or detecting an existing test condition, such as motion, heat or light and for converting the condition into an analog or digital representation to be relayed to the controller and displayed via the HMI 900.

The present invention has been illustrated in relation to a particular embodiment which is intended in all respects to be illustrative rather than restrictive. Those skilled in the art will recognize that the present invention is capable of many modifications and variations without departing from the scope of the invention. For example, as used herein, directional references such as “top”, “base”, “bottom”, “end”, “side”, “inner”, “outer”, “upper”, “middle”, “lower”, “front” and “rear” do not limit the respective sides of the carton testing apparatus or carton to such orientation, but merely serve to distinguish these sides from one another. Any reference to pivotable connection should not be construed as necessarily referring to a junction including a single pivot point only; indeed, it is envisaged that pivotable connection can be formed from one or more potentially disparate means for pivotably connecting materials. As used herein, “failure” of a carton or carrying means can be defined according to any industry or custom performance standard or metric.

Those skilled in the art will also appreciate that the shape and size of the apparatus for testing containers represents only one example of the various configurations that will be suitable for implementation of the various embodiments of the invention. For instance, the frame may be oval, round, or square, rather than rectangular. The entire testing apparatus may be open—that is, having no sides at all. Rather, the arm may be pivotably suspended from or connected to a post or pillar-like structure and the platform 126 may be hingedly or pivotably connected to another post. The size and shape of the container testing apparatus or any of its components may be adjusted to accommodate containers of differing sizes, shapes, weights, contents, and alternative wall structures may be used. The container testing apparatus may include more than one arm such as for testing a container having two handles, one at each of the ends of the container. Accordingly, the scope of the present invention is described by the claims appended hereto and supported by the foregoing.

What is claimed is:

1. An apparatus for testing. the structural integrity of a container having a handle, comprising:
support means;
a pendulum arm pivotably connected at a first end of said arm to said support means at a pivot point thereof;
grasping means for grasping said handle of said container to load said pendulum arm, said grasping means being connected to a second end of said arm; and
drive means for causing said pendulum arm to pivot about said pivot point.

2. The apparatus of claim 1, wherein said support means comprises a component of a frame.

3. The apparatus of claim 1, wherein said support means comprises a post.

4. The apparatus of claim 1, wherein said support means comprises a panel.

5. The apparatus of claim 1, wherein said grasping means comprises a simulated hand.

6. The apparatus of claim 5, wherein said simulated hand comprises at least one projection for engaging said handle.

7. The apparatus of claim 1, wherein said pendulum arm comprises means for articulation between said grasping means and said pendulum arm, wherein said articulation means movably connects said grasping means to said pendulum arm.

8. The apparatus of claim 7, wherein said articulation means comprises means for permitting the grasping means to pivot with respect to said pendulum arm.

9. The apparatus of claim 8, wherein said articulation means comprises means for permitting the grasping means to rotate on a longitudinal axis of said pendulum arm.

10. The apparatus of claim 7, wherein said articulation means comprises a means for dampening the pivoting of said grasping means.

11. The apparatus of claim 10, wherein said dampening means is further for dampening the pivoting of said grasping means by providing resistance, wherein the amount of resistance provided is proportional to the velocity at which the grasping means pivots.

12. The apparatus of claim 10, wherein said dampening means comprises a dashpot.

13. The apparatus of claim 7, wherein said articulation means includes means for rectifying the orientation of the grasping means such that the grasping means is aligned with said pendulum arm.

14. The apparatus of claim 13, wherein said rectifying means comprises at least one spring.

15. The apparatus of claim 13, wherein said rectifying means comprises an elastomeric material.

16. The apparatus of claim 1, wherein said drive means comprises a mechanical drive system.

17. The apparatus of claim 16, wherein said mechanical drive system includes at least one of the following: a crank, a weight driven escapement, a spring driven escapement.

18. The apparatus of claim 1, wherein said drive means comprises an electromechanical drive system.

19. The apparatus of claim 18, where in said electromechanical drive system includes at least one of the following: a rotary actuator, a servo motor.

20. The apparatus of claim 1, wherein said pivot point comprises a turntable to which said pendulum arm is connected; and
wherein said drive means generates rotational motion of said turntable.

21. The apparatus of claim 1, further comprising a controller and a user interface, wherein said controller is programmed to cause said drive means to cause said pendulum arm to pivot according to a predefined test protocol; and
wherein said user interface comprises:
at least one input device for passing to said controller at least one command that controls the performance of said test protocol; and
at least one output device for communicating data to an operator.

22. The apparatus of claim 1, further comprising a controller and a user interface, wherein said controller is programmed to cause said drive means to cause said pendulum arm to pivot according to a predefined test protocol; and
wherein said user interface comprises:
at least one input device for passing to said controller at least one parameter that controls the performance of said test protocol; and
at least one output device for communicating data to an operator.

23. The apparatus of claim 22, wherein said at least one parameter is selected from a group of values consisting of: velocity, angular rotation, acceleration, force, mass, deceleration, position, number of cycles, and duration.

24. A method for testing the structural integrity of a container having a handle, the method comprising:
placing said container on a raised platform;
grasping said container by said handle with a grasping means connected to a pendulum arm; and
removing said platform, thereby allowing said pendulum arm to pivot about a fixed pivot point.

25. The method of claim 24, wherein:
said pendulum arm is pivotably connected at a first end thereof to a support means at said pivot point; and
said grasping means is connected to a second end of said pendulum arm.

26. The method of claim 24, wherein said pendulum arm comprises means for articulation between said grasping means and said pendulum arm, wherein said articulation means movably connects said grasping means to said pendulum arm.

27. A method for testing the structural integrity of a container having a handle, the method comprising:
positioning a pendulum arm at a position of equilibrium;
grasping said container by said handle with a grasping means connected to said pendulum arm; and
causing said pendulum arm to oscillate at least once about a pivot point by:
swinging said pendulum arm from said equilibrium position to a first extreme angle of rotation; and
swinging said pendulum arm from said first extreme angle of rotation back through the position of equilibrium to a second extreme angle of rotation.

28. The method of claim 27, wherein causing said pendulum arm to oscillate comprises activating drive means for pivoting said pendulum arm about said pivot point.

29. The method of claim 27, further comprising causing said grasping means to articulate with respect to said pendulum arm using means for articulation that movably connects said grasping means to said pendulum arm.

30. A method for testing the structural integrity of a container having a handle, the method comprising:
positioning a pendulum arm at a position of equilibrium;
grasping said container by said handle with a grasping means connected to said pendulum arm; and
causing said pendulum arm to pivot at least once about a fixed pivot point by swinging said pendulum arm from said equilibrium position to a predefined extreme angle of rotation.

31. The method of claim 30, wherein causing said pendulum arm to oscillate comprises activating drive means for pivoting said pendulum arm about said pivot point.

32. The method of claim 30, further comprising causing said grasping means to articulate with respect to said pendulum arm using means for articulation that movably connects said grasping means to said pendulum arm.
